(19) United States
(12) Patent Application Publication
(10) Pub. No.: US 2007/0135064 A1
(43) Pub. Date: Jun. 14, 2007

(54) Method and apparatus for reducing phase imbalance in radio frequency signals

(76) Inventors: Charles R. Ruelke, Margate, FL (US); Jerry T. Bolton JR., Aventura, FL (US); Raul Salvi, Boca Raton, FL (US)

Correspondence Address: MOTOROLA, INC., 1303 EAST ALGONQUIN ROAD, IL01/3RD, SCHAUMBURG, IL, 60196, US

(21) Appl. No.: 11/298,070

(22) Filed: Dec. 9, 2005

(51) Int. Cl. H04B 1/04

(52) U.S. Cl. 455/110

(57) ABSTRACT

Systems and method for reducing phase imbalance in radio frequency (RF) signals are disclosed. The phase imbalance in an RF signal may be due to phase imbalance in the local oscillator used for upconversion in a transmitter, and downconversion in a receiver. The RF signal is converted to a digital signal. The phase imbalance in the digital signal is measured by using a digital signal processor. The digital signal processor generates a compensation signal in response to the measurement of the phase imbalance. The compensation signal is used to generate a tuning signal to tune the local oscillator used for the upconversion or downconversion, thereby reducing the phase imbalance.

### FIELD OF THE INVENTION

This invention generally relates to the field of communication systems, and more specifically to communication systems for reducing phase imbalance in radio frequency (RF) signals.

### BACKGROUND OF THE INVENTION

Radio communication systems are used to transmit and receive information over long distances. The fundamental blocks of radio communication systems include a Frequency Generation Unit (FGU), a transmitter, communication channels, and a receiver. A transmitter transmits a radio frequency (RF) signal, which is obtained by modulating a baseband signal. The baseband signal is modulated by using a carrier signal. In some cases, the baseband signal is not modulated directly. Instead, the baseband signal is modulated by using an intermediate frequency (IF) signal, and then up converted to the RF signal for transmission. In any case, the FGU generates the required carrier signal, whether IF or otherwise, so that the baseband signal may be modulated to the carrier signal and transmitted. Once transmitted, a receiver receives the transmitted RF signal and recovers the baseband signal from the transmitted RF signal. Further, in many radio communication systems, the transmitter and the receiver are combined into a single device called a transceiver.

Current radio communication systems use local oscillators (LOs) for converting baseband signals and RF signals in a process called direct conversion. For example, using an LO for transmitting, a baseband signal is up-mixed (also termed up-converted) to obtain an RF signal. Similarly, using an LO for receiving, the received RF signal is down-mixed (also termed down-converted) to obtain the baseband signal. The use of direct conversion LOs eliminates the need for using IF stages in transceivers. Therefore, the use of direct conversion LOs reduces cost by eliminating the need for using filters, amplifiers and other electronic components necessary for the IF stages.

The use of direct conversion LOs is critical to transceiver functionality. However, developing direct conversion LOs for use in multi-band (multiple frequency) radio communication systems (which is a current requirement) involves complex design techniques. Multi-band radio communication systems require that the direct conversion LOs be designed for high LO signal power, low noise, low cost and small size. One of the problems of satisfying these requirements is that a direct conversion LO design that meets these requirements may introduce a phase imbalance in LO signal generation. As is known to one of ordinary skill in the art, the phase imbalance is an error in phase difference between an in-phase component and a quadrature component of the LO signal. As a result, the direct conversion LO may introduce or increase the phase imbalance in the RF signal during up-mixing or increase the phase imbalance in the baseband signal during down-mixing.

Currently, there exists schemes for detecting and correcting the phase imbalance introduced by the direct conversion LO. One existing scheme utilizes a delay locked loop (DLL) to detect the phase imbalance where a phase detector in the DLL detects the phase difference between two delay signals. The DLL then generates a delay signal by varying the two delay signals with respect to a reference signal. The phase difference between each delay signal and the reference signal is then detected based on the variation. The DLL scheme is not advantageous because it introduces additional hardware that adds additional cost and space to the transceiver design.

An improved scheme utilizing a DLL to compensate for errors in the LO signal is called quadrature phase balancing. Quadrature phase balancing requires applying a correction signal within the DLL to compensate for errors in the LO signal, such that the up-mixed RF signal is corrected so as to achieve reduced system distortion. Currently known quadrature phase balancing schemes do not correct the phase imbalance so that the quadrature error targets are as small as possible and acceptable for certain applications. As such, requiring that the phase imbalance be as small as possible is a requirement on the direction conversion LO in addition to the requirements previously mentioned. Accordingly, there exists a need for a new method and apparatus for reducing phase imbalance in radio frequency signals.

### BRIEF DESCRIPTION OF THE FIGURES

The present invention is illustrated by way of example, and not limitation, in the accompanying figures, in which like references indicate similar elements, and in which:

FIG. 1 is a block diagram illustrating an exemplary communication network which may incorporate at least one base station and one mobile device in accordance with an embodiment of the present invention.

FIG. 2 is a block diagram illustrating a first communication system in accordance with an embodiment of the present invention.

FIG. 3 is a block diagram illustrating an exemplary digital signal processor in accordance with an embodiment of the present invention.

FIG. 4 is a block diagram illustrating an exemplary digital signal processor in accordance with another embodiment of the present invention.

FIG. 5 is a block diagram illustrating an example of a radio transceiver in accordance with one embodiment of the present invention.

FIG. 6 is a block diagram illustrating an example of a first communication system in a radio transceiver in accordance with one embodiment of the present invention.

FIG. 7 and FIG. 8 are flowcharts illustrating the steps involved in reducing phase imbalance in a radio frequency (RF) signal in accordance with an embodiment of the present invention.

FIG. 9 is a block diagram illustrating a second communication system in accordance with another embodiment of the present invention.

FIG. 10 is a block diagram illustrating an example of a second communication system in accordance with another embodiment of the present invention.

FIG. 11 is a block diagram illustrating a third communication system in accordance with yet another embodiment of the present invention.

FIG. 12 is a block diagram illustrating an example of a third communication system in accordance with one embodiment of the present invention.

FIG. 13 and FIG. 14 are flowcharts illustrating the steps involved in reducing phase imbalance in a radio frequency (RF) signal in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail the particular systems and method for reducing phase imbalance in RF signals, it should be observed that the present invention resides primarily in combinations of system components and method steps related to reducing phase imbalance in an RF signal. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including” and/or “having”, as used herein, are defined as comprising.

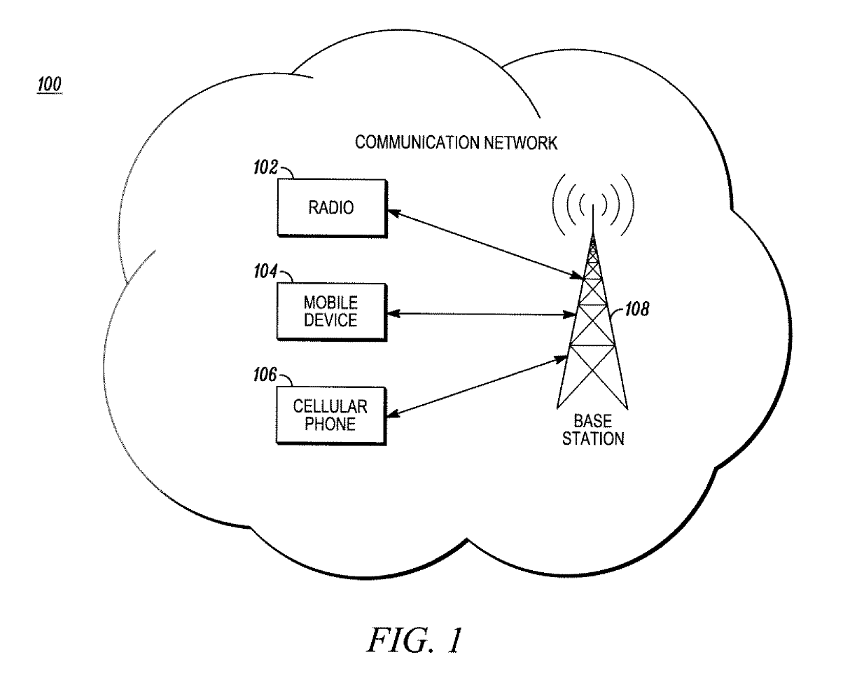

Various embodiments of the present invention provide for reducing phase imbalance in a radio frequency (RF) signal. As such, a explanation of an embodiment, is described with reference to FIG. 1. FIG. 1 is a block diagram illustrating a communication network 100 in accordance with an embodiment of the present invention. The communication network 100 may be geographically spread over an area such as an office, a city, a state, and so forth. Examples of the communication network 100 include a wireless Local Area Network (LAN), a wireless Wide Area Network (WAN), a cellular network, and the like. The communication network 100 includes multiple communication devices. Examples of the communication devices include radios, mobile phones, Personal Digital Assistants (PDAs), mobile computational devices, and the like. For example, the communication network 100 includes the communication devices of a radio 102, a mobile device 104, a cellular phone 106, and a base station 108. The communication devices communicate with each other by using various communication elements, such as transmitters, receivers, FGUs, transceivers, and communication channels. Examples of a communication channel include, but are not limited to, a specific radio frequency or a band of radio frequencies such as Wi-Fi and television channels. In an embodiment of the present invention, the radio 102 includes a transmitter and a receiver to communicate with the base station 108. Exemplary communication systems will now be described to illustrate the various embodiments of the present invention.

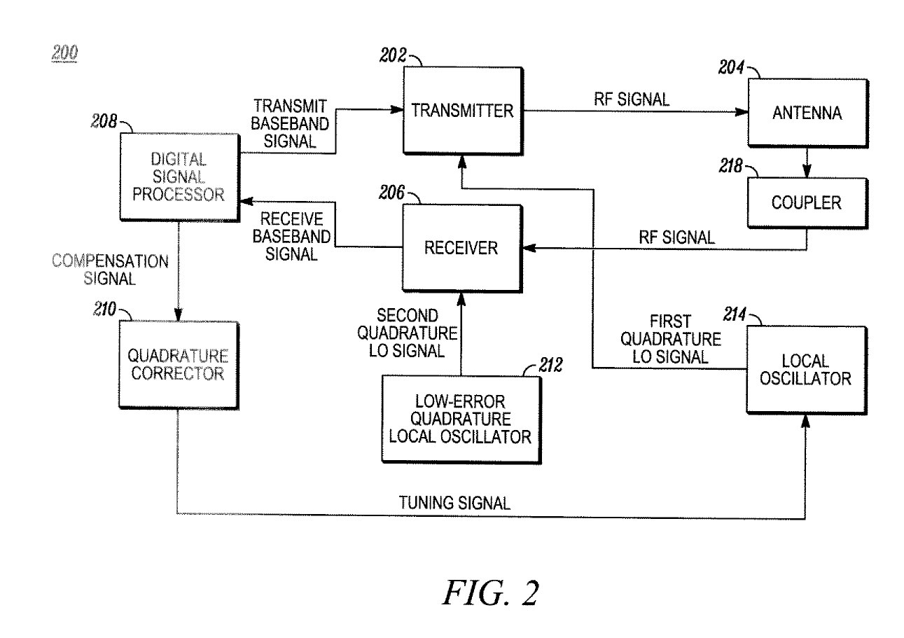

FIG. 2 is a block diagram illustrating a first communication system (also termed a communication device) 200 in accordance with an embodiment of the present invention. The communication system 200 includes a transmitter 202, an antenna 204, a receiver 206, a digital signal processor 208, a quadrature corrector 210, a low-error quadrature local oscillator 212, and a local oscillator (LO) 214. The communication system 200 can reside in the radio 102, the mobile device 104, the base station 108, or the like. In one embodiment, the receiver 206 comprises a Cartesian feedback block in addition to typical receiver elements (mentioned below).

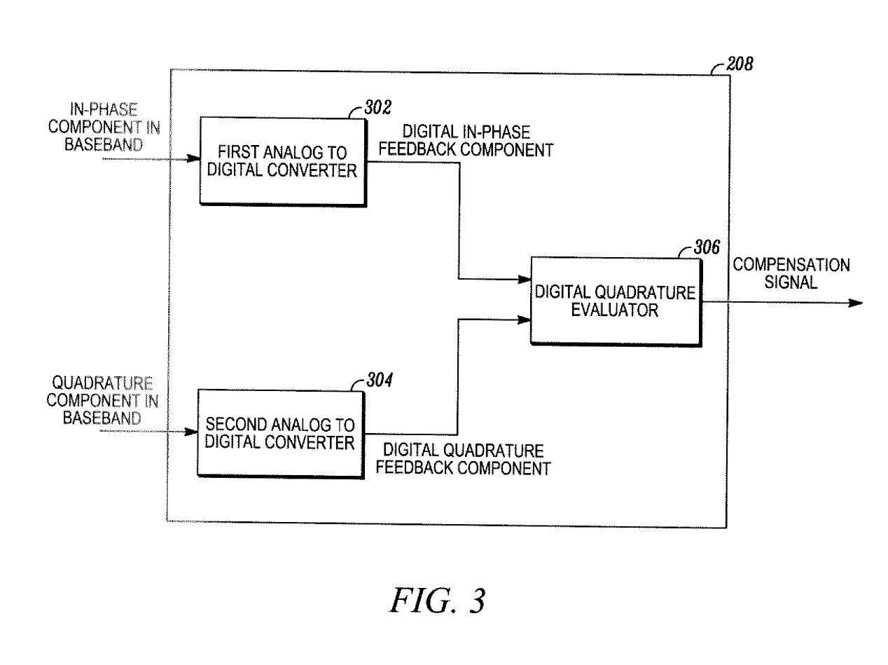

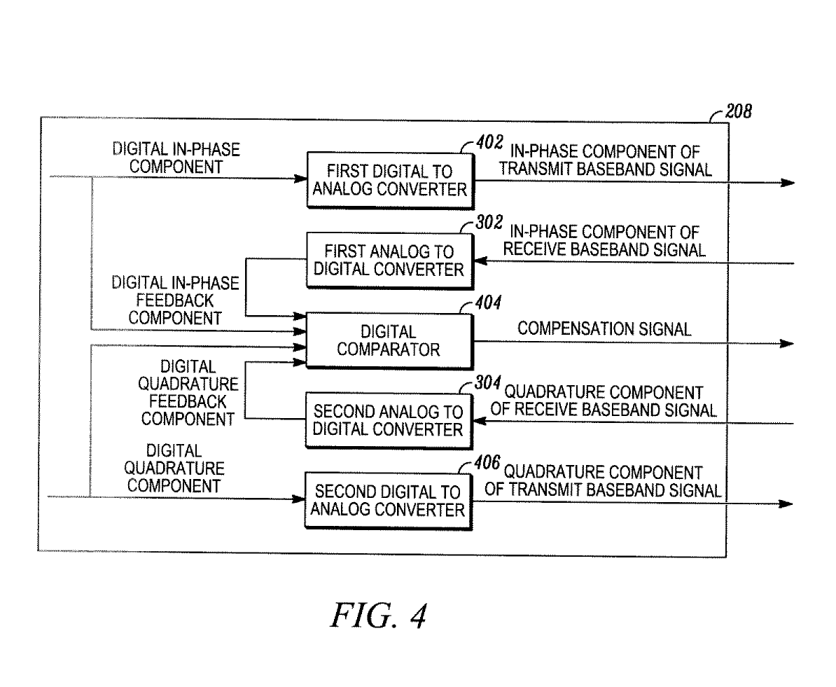

In operation, the digital signal processor 208 of the first communication system 200 generates a communication signal or a transmit baseband signal. In an embodiment of the present invention, the transmit baseband signal is an analog signal which has an in-phase and a quadrature component. The digital signal processor 208 provides the transmit baseband signal to the transmitter 202. The digital signal processor 208 will be explained later in conjunction with FIGS. 3 and 4. The LO 214 provides a first quadrature LO signal to the transmitter 202. The first quadrature LO signal has an in-phase and a quadrature component and is likely to have an error in phase difference between the in-phase and the quadrature component. For example, the error in the phase difference between the in-phase component and the quadrature component of the first quadrature LO signal can vary as much as + or −6 degrees without compensation. This error in the phase difference of the in-phase component and the quadrature component is referred to as phase imbalance.

Referring to FIG. 2, the transmitter 202 up-mixes the transmit baseband signal with the first quadrature LO signal to generate a radio frequency (RF) signal. Since the first quadrature LO signal has a phase imbalance, the RF signal similarly has a phase imbalance. This RF signal is transmitted by the communication system 200 to a receiving communication device. As is known to one of ordinary skill in the art, the transmitter 202 includes components such as filters, up-mixers, RF gain control circuits, and RF power amplifiers (not shown) to perform the functions of upmixing and transmitting.

The RF signal is transmitted via antenna 204 to external communication devices. The RF signal is also coupled into the receiver 206 through a coupling structure 218. In the receiver 206, the RF signal is downmixed with a second quadrature LO signal from the low-error quadrature LO 212 to obtain a receive baseband signal. The receive baseband signal will have an in-phase and a quadrature component in baseband. In one embodiment the low-error quadrature LO 212 is an LO signal generator with a low error in the phase difference between the in-phase and quadrature component. As used herein, low error is defined as likely to be less than approximately 0.5 degrees. In an embodiment of the present invention, the low-error quadrature LO 212 is external to or is not a part of the communication system 200. For example, the communication system 200 can be an integrated circuit in the base station 108 with the low-error quadrature LO 212 being external to the integrated circuit. In another embodiment, the LO source 212 can also be an external factory LO source applied during factory tuning procedures of the first communication system 200.

As mentioned, in an embodiment of the present invention, the receiver 206 includes components such as a Cartesian feedback block, down mixers, low-noise amplifiers, and baseband amplifiers. The digital signal processor 208 determines the phase imbalance in the receive baseband signal and generates a compensation signal. The compensation signal is used for correcting the phase imbalance of the quadrature LO signals. The compensation signal is supplied to the quadrature corrector 210. The quadrature corrector 210 generates a tuning signal based on the compensation signal to tune the local oscillator 214 in order to correct the phase imbalance. In an embodiment of the present invention, the quadrature corrector 210 includes a phase shifter for correcting the phase imbalance.

FIG. 3 is a block diagram illustrating the digital signal processor 208 in accordance with one embodiment of the present invention. For the purpose of this description, the digital signal processor 208 includes a first analog to digital converter 302, a second analog to digital converter 304, and a digital quadrature evaluator 306. Even though only three elements, namely 302, 304, and 306, are shown in FIG. 3, as is known to one of ordinary skill in the art, a digital signal processor may include many other processing elements not shown.

Referring to FIG. 3, the first analog to digital converter 302 converts the in-phase component of the receive baseband signal to a digital in-phase feedback component. The second analog to digital converter 304 converts the quadrature component of the receive baseband signal to a digital quadrature feedback component. The digital quadrature evaluator 306 compares the digital in-phase feedback component and the digital quadrature feedback component. As is known to one of ordinary skill in the art, the in-phase component may be associated with one signal and the quadrature component may be associated with three signals. In one embodiment, the comparison is accomplished by defining the phase of the in-phase component as a reference phase (e.g. 0 degrees), and subtracting the sampled phase values of the other quadrature sources from the reference. It is known a priori that the phase of each quadrature element should be shifted from the reference by integer multiples of 90 degrees (e.g. 90, 180, and 270). The difference between the expected value and the measured value is the quadrature phase error. The digital quadrature evaluator 306 generates a compensation signal based on the comparison. This compensation signal is used to correct the phase imbalance in the received RF signal. In one embodiment, the correction of the phase imbalance is accomplished by selecting different delay-taps within the e.g. a DLL generating the LOs, so as to shift the phase of the quadrature elements independently. As is known to one of ordinary skill in the art, the DLL tap selection is done so as to minimize the phase error relative to the in-phase reference, thereby minimizing the phase imbalance. As used herein, independently means that each of the quadrature elements is shifted independent of the other quadrature elements. For example, the 90 degrees quadrature element may be controlled independently of either the 180 degrees and/or 270 degrees elements.

FIG. 4 is a block diagram illustrating the digital signal processor 208 in accordance with another embodiment of the present invention. In this embodiment, the digital signal processor 208 includes a first digital to analog converter 402, the first analog to digital converter 302, a digital comparator 404, the second analog to digital converter 304, and a second digital to analog converter 406. The first digital to analog converter 402 generates an analog in-phase component from a digital in-phase component of the receive baseband signal. The second digital to analog converter 406 generates an analog quadrature component from a digital quadrature component of the receive baseband signal. The analog in-phase and quadrature components are combined to obtain the transmit baseband signal. The first analog to digital converter 302 generates a digital in-phase feedback component from the in-phase component of the receive baseband signal. The second analog to digital converter 304 generates a digital quadrature feedback component from the quadrature component of the receive baseband signal. The digital comparator 404 compares the digital in-phase feedback component with the digital in-phase component. The digital comparator 404 also compares the digital quadrature feedback component with the digital quadrature component. From the two comparisons, the digital comparator 404 generates the compensation signal that is used to reduce the phase imbalance in the received RF signal.

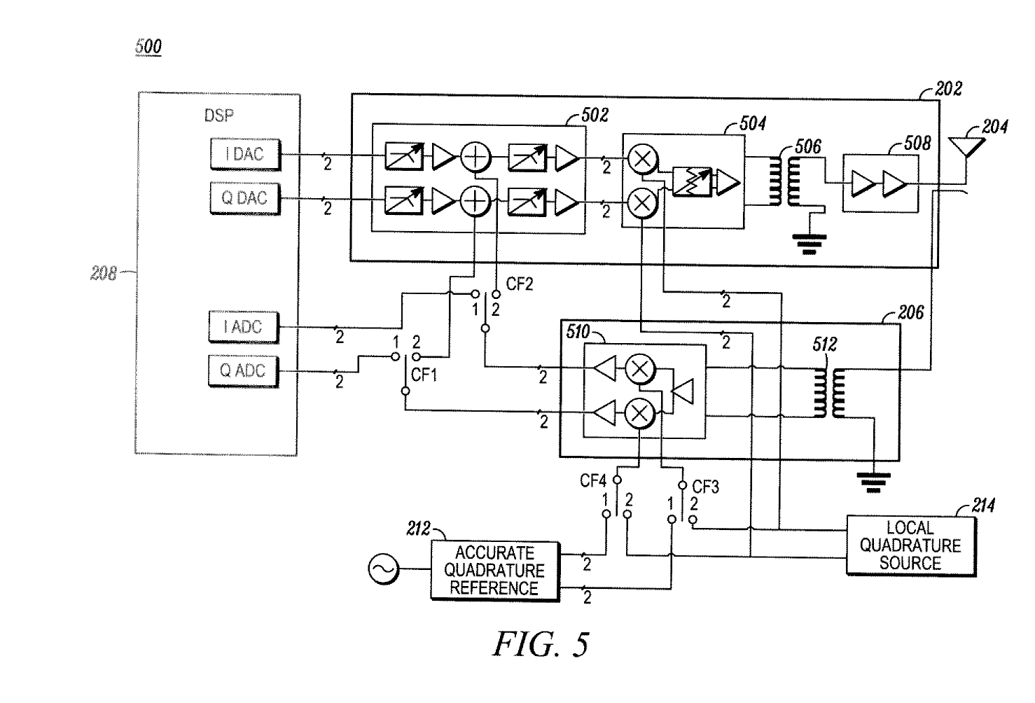

FIG. 5 is a block diagram illustrating an example of a radio transceiver 500 in accordance with one embodiment of the present invention. The radio transceiver 500 includes the transmitter 202, the antenna 204, the digital signal processor 208, the receiver 206 including a Cartesian feedback block 510, the LO 214, the low-error quadrature LO 212, and a set of switches CF1, CF2, CF3, and CF4. The transmitter 202 includes a baseband modulator 502, a baseband-to-RF upconverter 504, a differential-to-single ended transformation block 506 and an RF power amplifier (RFPA) 508. The baseband modulator 502 includes a set of filters and amplifiers. The receiver 206 including the Cartesian feedback block 510 includes a mixer and amplifier block and a single ended-to-differential conversion block 512. The digital signal processor 208 generates the transmit baseband signal as described earlier. In the transmitter 202, the transmit baseband signal is filtered by the filters in the baseband modulator 502. In the baseband-to-RF upconverter 504, the filtered signal from the baseband modulator 502 is modulated using the first quadrature LO signal from the LO 214 to obtain the RF signal. The RF signal is then amplified by the RFPA 508. The RF signal is radiated to the external world by the antenna 204 and simultaneously coupled to the receiver 206.

In the receiver 206, the RF signal is converted from single-ended to a differential signal at the single ended-to-differential block 512. The Cartesian feedback block 510 is used for transmitter linearization. The Cartesian feedback block 510 demodulates the RF signal using the LO 214 to obtain the in-phase and quadrature components of the receive baseband signal. The switches CF3 and CF4 are connected in position 2 for normal operation of the transmitter with Cartesian feedback block 510 as shown in FIG. 5. The in-phase and quadrature components of the receive baseband signal are then provided to the mixers in the baseband modulator 502 to remove the distortion in the RF signal during transmission. The switches CF1, CF2 are connected in position 2 to perform the baseband linearization during normal transmit operation. When the phase imbalance of the frequency source, namely LO 214, is being measured, switches CF1 and CF2 are set to position 1 to route the quadrature received signal (e.g. first quadrature LO signal shown in FIG. 2) to the digital signal processor 208 for measurement. In one embodiment of the invention, compensation of the frequency source, namely LO 214, is achieved using internal low-error quadrature source 212 by setting switches CF3 and CF4 to position #1. This ensures that the measured quadrature error is attributable to the local oscillator 214 which is still connected into the system at the up mixers in block 504. In another embodiment of the invention, an external frequency referenced source (not shown in FIG. 5), may be used to facilitate measuring the quadrature error, in which case switches CF3 and CF4 may be left in position #2

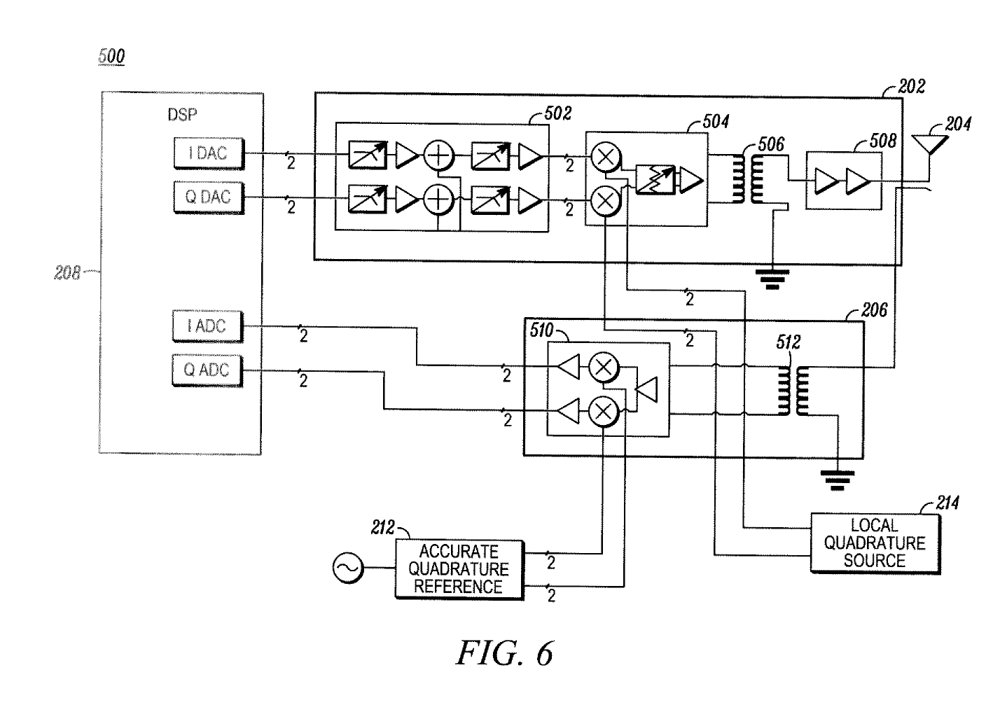

FIG. 6 is a block diagram illustrating an example of the first communication system 200 where switches CF1, CF2, CF3 and CF4 in the radio transceiver of FIG. 5 are set to position #1. The communication system 200 includes the transmitter 202, the antenna 204, the digital signal processor 208, the receiver 206, the LO 214 and the low-error quadrature LO 212. The function of the transmitter 202 is similar to as described earlier. However, in such an embodiment, the Cartesian feedback block 510 of the receiver 206 downmixes the RF signal with the second quadrature LO signal from the low-error quadrature LO 212 to obtain the receive baseband signal. By doing so, the measured quadrature error is attributable to the local oscillator 212 which is still connected into the system at the up mixers in block 504.

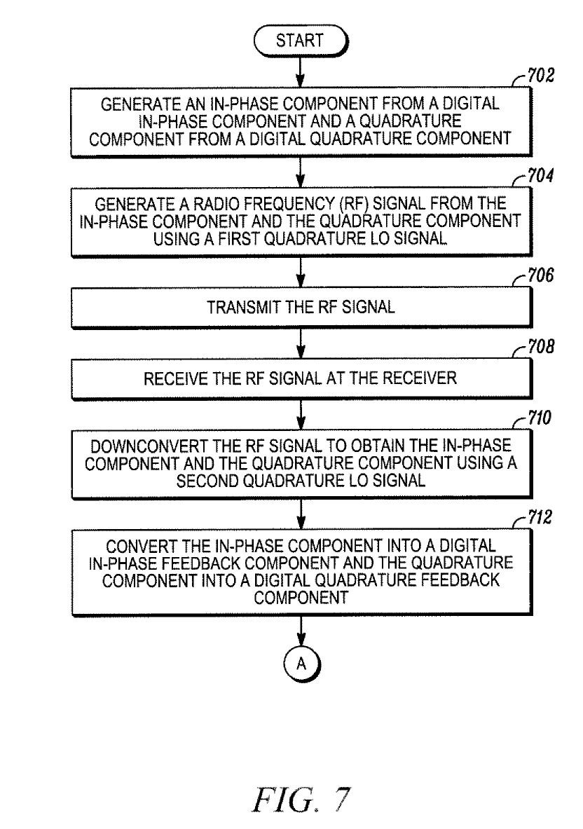

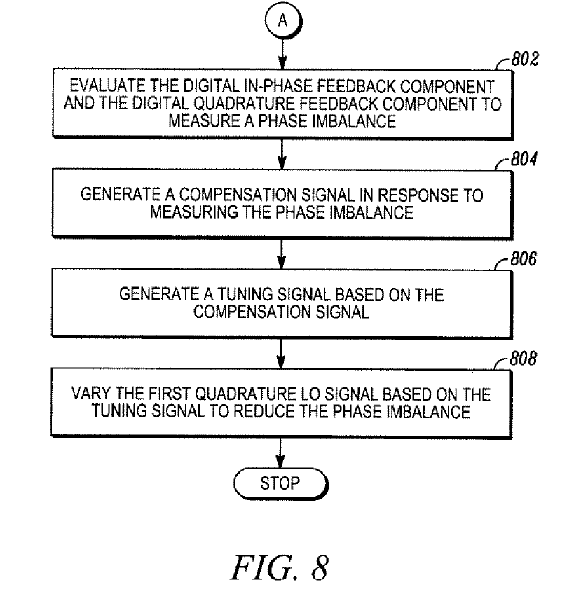

FIG. 7 and FIG. 8 are flowcharts illustrating the steps involved in reducing phase imbalance in the RF signal in accordance with an embodiment of the present invention. At step 702, the in-phase component of the transmit baseband signal is generated from the second digital in-phase component. Similarly, the quadrature component of the transmit baseband signal is generated from the second digital quadrature component.

At step 704, the RF signal is generated from the in-phase component and the quadrature component by using a first quadrature LO signal. In one embodiment of the present invention, the RF signal is generated by filtering the in-phase component and the quadrature component of the transmit baseband signal to remove noise and then upconverting the transmit baseband signal to the RF signal. The transmit baseband signal is upconverted by modulating the first quadrature LO signal with the transmit baseband signal using mixers.

At step 706, the RF signal is transmitted by the transmitter 202. For the purpose of transmission, the RF signal is amplified by using RF gain control circuits and RF power amplifiers. The RF signal is then radiated through the antenna 204.

At step 708, the RF signal is received by the receiver 206. In an embodiment of the present invention, the RF signal is amplified by a low-noise amplifier upon receiving it.

At step 710, the RF signal is downconverted to generate the in-phase component and the quadrature component of the receive baseband signal. In an embodiment of the present invention, a downconverter downconverts the RF signal. Further, the in-phase and quadrature components of the receive baseband signal are generated by amplifying the baseband signal using baseband amplifiers.

At step 712, the in-phase component of the receive baseband signal is converted to the digital in-phase feedback component by the first analog to digital converter 302, and the quadrature component of the receive baseband signal is converted to the digital quadrature feedback component by the second analog to digital converter 304. In one embodiment, the in-phase component is defined as a reference signal (e.g. having a phase of 0 degrees) and the quadrature component comprises three signals of integer multiples of 90 degrees (e.g. 90, 180, and 270) of the reference signal.

Referring now to FIG. 8, at step 802, the digital in-phase feedback component and the digital quadrature feedback component are evaluated. In an embodiment of the present invention, the digital quadrature evaluator 306 evaluates the digital in-phase feedback component and the digital quadrature feedback component by comparing the digital in-phase feedback component with the digital quadrature feedback component. By doing so, the digital quadrature evaluator 306 measures the phase imbalance between the in-phase component in baseband and the quadrature component in baseband.

At step 804, a compensation signal is generated by the digital signal processor 208 in response to the measurement of the phase imbalance. At step 806, a tuning signal is generated by the quadrature corrector 210 based on the compensation signal. The tuning signal is used to tune the LO 214. At step 808, the first quadrature LO signal is varied based on the tuning signal to reduce the phase imbalance.

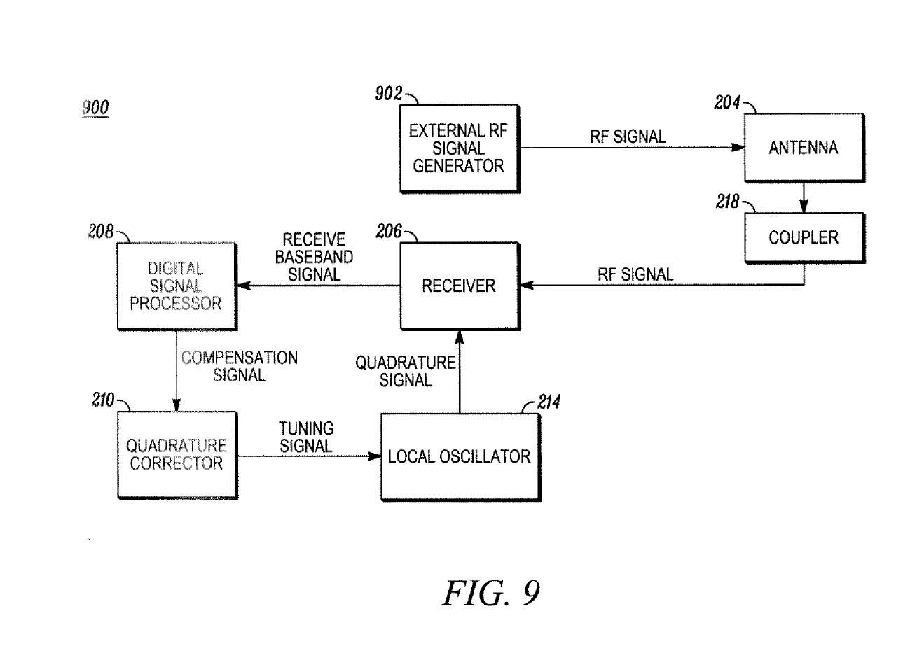

FIG. 9 is a block diagram illustrating a second communication system 900 in accordance with another embodiment of the present invention. The communication system 900 includes an external RF signal generator 902, the antenna 204, the coupler 218, the receiver 206, the digital signal processor 208, the quadrature corrector 210, and the LO 214. As is known to one of ordinary skill in the art, the second communication system 900 may include many other processing elements not shown.

In such an embodiment, the external RF signal generator 902 generates the RF signal. The RF signal is received by the receiver 206 through the antenna 204 and coupler 218. In the receiver 206, the RF signal is downmixed with the quadrature signal from the LO 214 to obtain the receive baseband signal. In an embodiment of the present invention, the receiver 206 includes components such as Cartesian feedback blocks, down mixers, low-noise amplifiers, and baseband amplifiers. The digital signal processor 208 generates the compensation signal which is provided to the quadrature corrector 210. The function of the digital signal processor 208 is similar to the description in conjunction with FIG. 3.

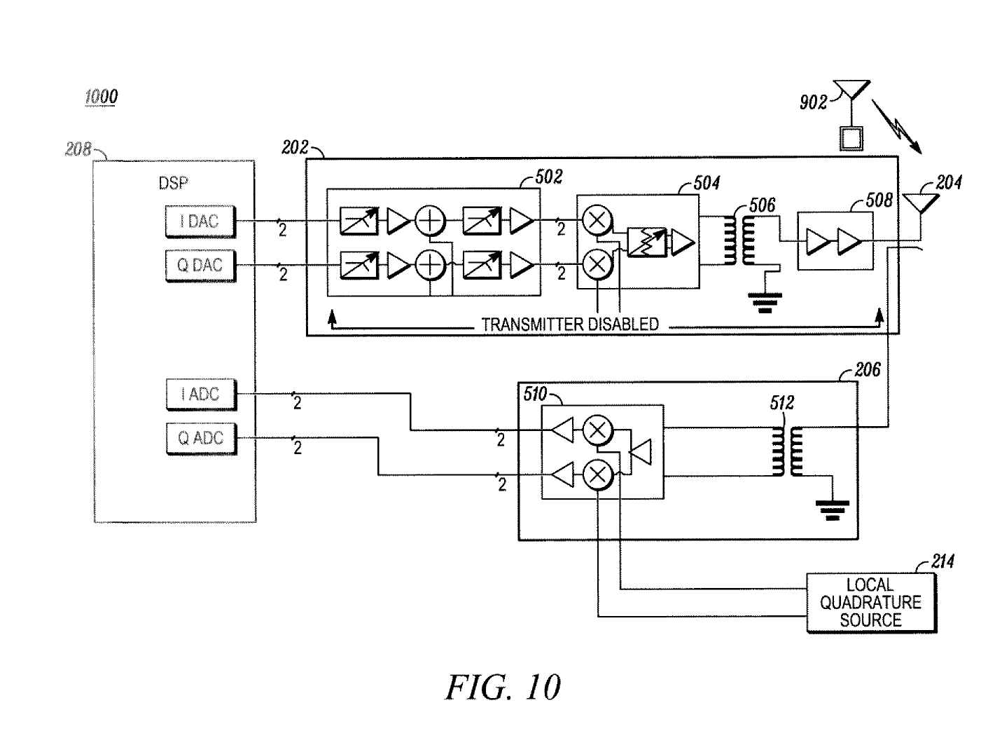

FIG. 10 is a block diagram illustrating an example of the second communication system 900 in accordance with one embodiment of the present invention as described in FIG. 5 when switches CF1 and CF2 are placed in position #1 and CF3 and CF4 are placed in position #2. The communication system 1000 includes the digital signal processor 208, the external RF signal generator 902, the receiver 206, the LO 214 and the low-error quadrature LO 212. In this case, the transmitter 202 is disabled. The function of the digital signal processor 208 is as described in conjunction with FIG. 3. The Cartesian feedback block 510 in the receiver 206 downmixes the RF signal with the second quadrature LO signal from the LO 214 to obtain the receive baseband signal.

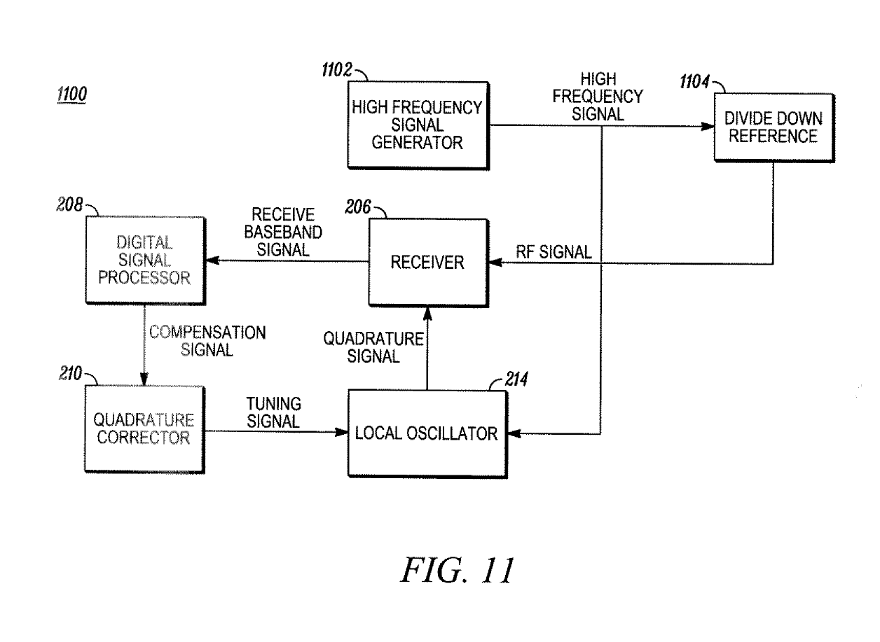

FIG. 11 is a block diagram illustrating a third communication system 1100 in accordance with an embodiment of the present invention. The communication system 1100 includes a high frequency signal generator 1102, a divide down reference 1104, the receiver 206, the digital signal processor 208, the quadrature corrector 210, and the LO 214. As is known to one of ordinary skill in the art, the third communication system 1100 may include many other processing elements not shown.

The high frequency signal generator 1102 generates a high frequency signal. For example, the high frequency signal generator generates a signal of frequency 1 GHz. The high frequency signal is divided down to the RF signal by the divide down reference 1104. For example, the divide down reference 1104 includes a frequency divider to reduce the frequency of the 1 GHz signal to obtain the RF signal. In an embodiment of the present invention, the divide down reference 1104 generates a RF single tone (unmodulated) signal.

The receiver 206 receives the RF signal. In the receiver 206, the RF signal is downmixed with the quadrature signal from the LO 214 to obtain the receive baseband signal. The digital signal processor 208 generates the compensation signal, which is provided to the quadrature corrector 210 to correct the error of LO 214. The function of the digital signal processor 208 is similar to the description illustrated in FIG. 3.

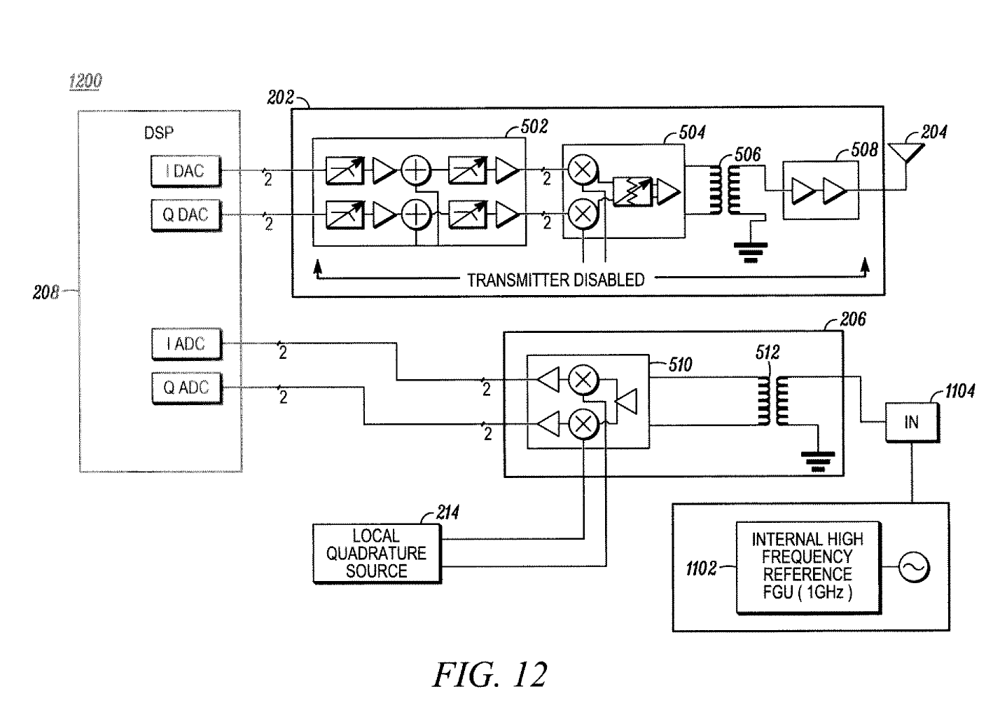

FIG. 12 is a block diagram illustrating an example of the third communication system 1100 in accordance with one embodiment of the present invention. The communication system 1200 includes the digital signal processor 208, the high frequency signal generator 1102, the receiver 206, the LO 214, and the divide down reference 1104. The function of the digital signal processor 208 is described earlier in conjunction with FIG. 3. The Cartesian feedback block 510 of the receiver 206 downmixes the RF signal with the quadrature signal from the LO 214 to obtain the receive baseband signal. While it is not shown, a person of ordinary skill in the art would understand that FIG. 12 could be incorporated into FIG. 5 if another switch was added between the antenna 204 and the single ended-to-differential conversion block 512 that selects between the divide down reference 1104 and the RF signal at antenna 204.

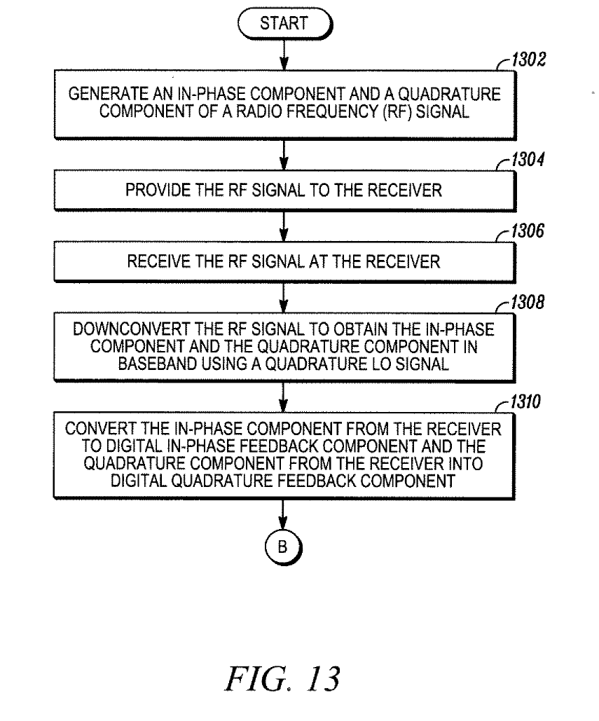

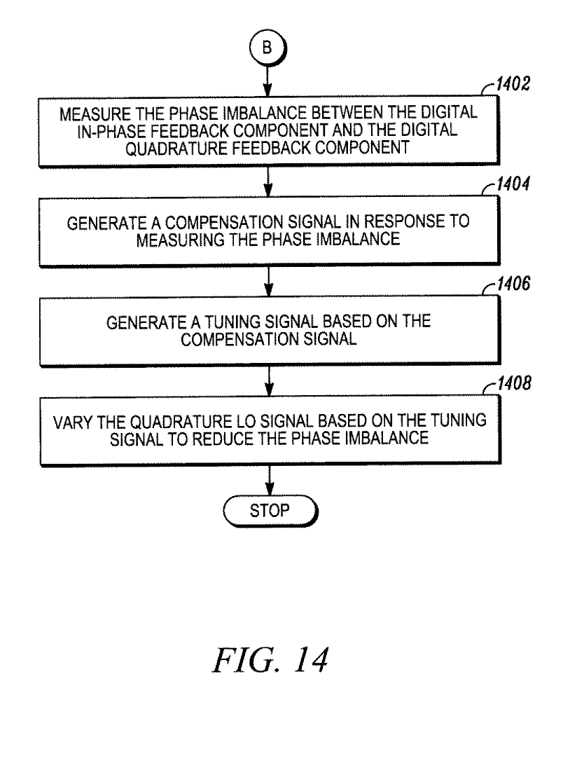

FIG. 13 and FIG. 14 are flowcharts illustrating the steps involved in reducing the phase imbalance in the RF signal in accordance with an embodiment of the present invention. These steps are applicable to both communication systems 900 and 1100. At step 1302, a single tone RF signal is generated. At step 1304, the RF signal is provided to the receiver 900. At step 1306, the RF signal is received by the receiver 206. Receiving the RF signal includes amplifying the RF signal by using a low-noise amplifier. At step 1308, the RF signal is downconverted to generate the in-phase and quadrature components of the receive baseband signal. In an embodiment of the present invention, a downconverter downconverts the RF signal to the receive baseband signal by modulating a LO quadrature signal with the RF signal by using the mixers. The local oscillator 214 generates the quadrature signal for the downconversion. At step 1310, the in-phase component of the receive baseband signal is converted to the digital in-phase feedback component by the first analog to digital converter 302 and the quadrature component of the receive baseband signal is converted to the digital quadrature feedback component by the second analog to digital converter 304.

Referring now to FIG. 14, at step 1402, the digital in-phase feedback component and the digital quadrature feedback component are evaluated. In an embodiment of the present invention, the digital quadrature evaluator 306 evaluates the digital in-phase feedback component and the digital quadrature feedback component by comparing the digital in-phase feedback component with the digital quadrature feedback component. By doing so, the digital quadrature evaluator 306 measures the phase imbalance between the in-phase component in baseband and the quadrature component in baseband. At step 1404, a compensation signal is generated by the digital signal processor 208 in response to the measurement of the phase imbalance. At step 1406, the tuning signal is generated by the quadrature corrector 210. The tuning signal is used to tune the local oscillator's quadrature phase to minimize phase error. At step 1408, the quadrature signal of the local oscillator 214 is varied based on the tuning signal to reduce the phase imbalance.

Therefore, it should be clear from the preceding discussion that the present invention provides systems and methods for reducing phase imbalance in RF signals. This system reduces phase imbalance by varying the phase quadrature of a local oscillator signal used for upconversion in a transmitter, and/or downconversion in a receiver. This reduces the performance requirements of the local oscillator used in the transmitter or the receiver by not requiring absolute phase accuracy. Further, the method can use a Cartesian feedback block for downconverting to remove the phase imbalance.

It is expected that one of ordinary skill, notwithstanding possibly significant effort and many design choices motivated by, for example, available time, current technology and economic considerations, when guided by the concepts and principles disclosed herein, will be readily capable of generating such software instructions, and programs and ICs with minimal experimentation.

In the foregoing specification, the invention and its benefits and advantages have been described with reference to specific embodiments. However, one of ordinary skill in the art would appreciate that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage or solution to occur or become more pronounced are not to be construed as a critical, required or essential features or elements of any or all the claims. The invention is defined solely by the appended claims, including any amendments made during the pendency of this application, and all equivalents of those claims as issued.

What is claimed is:

1. A communication system capable of reducing phase imbalance between an in-phase component and a quadrature component of a communication signal, the communication system comprising:
a transmitter capable of generating a radio frequency (RF) signal from the in-phase component and the quadrature component by using a first quadrature local oscillator signal;
a receiver capable of receiving the RF signal, and downconverting the RF signal to obtain the in-phase component and the quadrature component using a second quadrature local oscillator signal, wherein the second quadrature local oscillator signal is provided by a low-error quadrature local oscillator;
a digital signal processor capable of generating the in-phase component and the quadrature component, and measuring the phase imbalance between the in-phase component and the quadrature component upon downconverting the RF signal; and
a quadrature corrector capable of providing a phase correction between the in-phase component and the quadrature component based on the phase imbalance by varying the first quadrature local oscillator signal.

2. The communication system according to claim 1, wherein the transmitter comprises an upconverter capable of upconverting the communication signal to the RF signal using the first quadrature local oscillator signal.

3. The communication system according to claim 1, wherein the receiver comprises a downconverter capable of downconverting the RF signal to obtain the in-phase component and the quadrature component using the second quadrature local oscillator signal.

4. The communication system according to claim 1, wherein the receiver further comprises a cartesian feedback block.

5. The communication system according to claim 1, wherein the low-error quadrature local oscillator is at least one of a) an external local oscillator and b) an internal local oscillator.

6. The communication system according to claim 1, wherein the digital signal processor is further capable of generating a compensation signal in response to measuring the phase imbalance.

7. The communication system according to claim 6, wherein the quadrature corrector generates a tuning signal based on the compensation signal to vary the first quadrature local oscillator signal.

8. The communication system according to claim 1, wherein the digital signal processor comprises:
a first analog to digital converter for converting the in-phase component from the receiver to a digital in-phase feedback component;
a second analog to digital converter for converting the quadrature component from the receiver to a digital quadrature feedback component; and
a digital quadrature evaluator for measuring the phase imbalance between the digital in-phase feedback component and the digital quadrature feedback component to generate the compensation signal.

9. The communication system according to claim 8, wherein the digital signal processor further comprises:
a first digital to analog converter for generating the in-phase component of the communication signal from a digital in-phase component; and
a second digital to analog converter for generating the quadrature component of the communication signal from a digital quadrature component.

10. The communication system according to claim 9, wherein the digital quadrature evaluator comprises a digital comparator for measuring the phase imbalance between the digital in-phase feedback component and the digital quadrature feedback component by comparing the digital in-phase feedback component with the digital in-phase component, and the digital quadrature feedback component with the digital quadrature component.

11. A communication system capable of reducing phase imbalance between an in-phase component and a quadrature component of a radio frequency (RF) signal, the communication system comprising:
a receiver capable of receiving the RF signal, and downconverting the RF signal using a quadrature local oscillator signal to obtain the in-phase component and the quadrature component in baseband;
a digital signal processor capable of measuring the phase imbalance between the in-phase component and the quadrature component in baseband; and
a quadrature corrector capable of providing a phase correction between the in-phase component and the quadrature component in baseband based on the phase imbalance between the in-phase component and the quadrature component in baseband by varying the quadrature local oscillator signal.

12. The communication system according to claim 11, further comprising an RF signal generator for generating and transmitting the RF signal.

13. The communication system according to claim 11, further comprising a divide down reference to obtain the RF signal by dividing a high frequency signal.

14. The communication system according to claim 11, wherein the receiver comprises a downconverter for downconverting the RF signal to obtain the in-phase component and the quadrature component in baseband using the quadrature local oscillator signal.

15. The communication system according to claim 1 1, wherein the digital signal processor is further capable of generating a compensation signal in response to measuring the phase imbalance.

16. The communication system according to claim 15, wherein the digital signal processor comprises:
a first analog to digital converter for converting the in-phase component in baseband to a digital in-phase feedback component;
a second analog to digital converter for converting the quadrature component in baseband to a digital quadrature feedback component; and
a digital quadrature evaluator for measuring the phase imbalance between the digital in-phase feedback component and the digital quadrature feedback component to generate the compensation signal.

17. A method for reducing phase imbalance in a radio frequency (RF) signal, the RF signal comprising an in-phase component and a quadrature component, the method comprising:
receiving the RF signal;
downconverting the RF signal to obtain the in-phase component and the quadrature component in baseband, using a quadrature local oscillator signal, wherein the in-phase component is associated as a reference signal and the quadrature component comprises three signals approximately 90, 180, and 270 degrees phase shifted relative to the reference signal;
detecting the phase imbalance between the in-phase component and the quadrature component in baseband; and
providing a phase correction to reduce the phase imbalance by controlling the phase of a first signal of the three signals independent of a second signal of the three signals.

18. The method according to claim 17, wherein detecting the phase imbalance comprises:
converting the in-phase component in baseband to a digital in-phase feedback component;
converting the quadrature component in baseband to a digital quadrature feedback component; and
measuring the phase imbalance between the digital in-phase feedback component and the digital quadrature feedback component.

19. The method according to claim 18, wherein providing the phase correction comprises:
generating a compensation signal based on the phase imbalance;
generating a tuning signal based on the compensation signal; and
varying the quadrature local oscillator signal based on the tuning signal to reduce the phase imbalance.
